(19) United States
(12) Patent Application Publication
(10) Pub. No.: US 2020/0098033 A1
(43) Pub. Date: Mar. 26, 2020

(54) METHOD FOR SELECTING A PASSENGER COMPARTMENT AIR FILTER, CORRESPONDING TERMINAL AND MOTOR VEHICLE

(71) Applicant: Valeo Systemes Thermiques, Le Mesnil Saint-Denis (FR)

(72) Inventors: Georges De Pelsemaeker, Le Mesnil Saint-Denis (FR); Laetitia Clemaron, Le Mesnil Saint-Denis (FR); Marion Deveycx, Le Mesnil Saint-Denis (FR)

(73) Assignee: Valeo Systemes Thermiques, Le Mesnil Saint-Denis (FR)

(21) Appl. No.: 16/583,911

(22) Filed: Sep. 26, 2019

(30) Foreign Application Priority Data
Sep. 26, 2018 (FR) 1858823

(51) Int. Cl. G06Q 30/06; G06F 16/9035

(52) U.S. Cl. CPC G06Q 30/0631; B60H 3/06; G06F 16/9035

(57) ABSTRACT

A method for selecting a passenger compartment air filter of a vehicle via a terminal for communicating with a remote data server having at least a data storage platform in which are listed a plurality of motor vehicle passenger compartment air filters and their characteristics and comprising a data base of user profiles, is disclosed. The method involves retrieving an item of information of identification of a user profile from among user profiles stored, retrieving at least one parameter of identification of the model of the vehicle, and retrieving data of utilization of the vehicle by the user. The retrieved information is used to construct a utilization history of the vehicle on the basis of the data retrieved for a minimum period of time. The compatibilities of the listed passenger compartment air filters are compared with the identified model to select at least one air filter suitable for the user.

The present invention relates to the domain of motor vehicles, in particular to the protection of the occupants of the motor vehicle with regard to the pollution of the air destined for the passenger compartment of the motor vehicle.

The invention relates to a method for selecting an air filter as a function of a user profile. The invention also relates to a terminal making it possible to at least partly implement such a method. The invention also relates to a motor vehicle comprising such an onboard terminal.

Air pollution is increasingly problematic and this is increasingly the subject of communication. In order to improve the quality of the air sent to the passenger compartment, it is known to install, in a passenger compartment of a motor vehicle, one or more air filters which are placed in the flow of air to the purified.

The air filter is likely to be integrated in a ventilation, heating and/or air conditioning installation, or it can be integrated in an independent and autonomous device or module installed in any place in the passenger compartment.

There are various kinds of air filters.

For example, particle air filters are known which make it possible to capture the particles and dust of a given diameter, such as pollen, soot or tyre wear residues. Processings making it possible to block bacterial proliferation can be provided. However, these systems do not make it possible to prevent the development of bad odours for the occupants of the passenger compartment.

Combined filters are known for this purpose, that is to say filters additionally making it possible, in addition to stopping particles and dust, to hold back bad odours, toxic gasses such as nitrogen oxide or dioxide, nitrogen, ozone, butane, toluene, sulphur dioxide, butadiene or other gasses.

Moreover, faced with the increase in the number of allergic people, it has been proposed to enhance the effectiveness of filtration and reduce the risk of allergy for people in contact with the filtered air, in particular for the driver for whom the occurrence of allergic symptoms, such as sneezing, can endanger the safety of the occupants of the motor vehicle. In this context, combined air filters with an additional function, for example anti-allergenic combined air filters, make it possible, in addition to the functions of a combined air filter, to neutralize allergens. Such air filters thus help to protect the occupants du motor vehicle.

However, users are do not necessarily know about the type of air filter they must use in order to best protect them in their motor vehicles, notably if they are subject to allergies and can use air filters that are chosen randomly and which are not necessarily the most appropriate.

Moreover, depending on the motor vehicle, all air filters are not necessarily suitable.

In fact, the particles and other things that are held back by the air filter can generate a phenomenon of clogging that filter, which means that it induces large pressure drops reducing the air flow rate passing through the air filter and therefore the performance of the heating and/or ventilation and/or air conditioning installation. According to the model or the range of the motor vehicle, it can be that the air blower of the heating and/or ventilation and/or air conditioning installation does not have sufficient power to include an air filter generating many pressure drops as can be the case for a combined air filter or a combined air filter with additional function.

The purpose of the invention is to at least partially overcome these problems of the prior art by making it possible to identify in a pertinent manner a suitable air filter for best protecting the occupants of a motor vehicle.

For this purpose, the invention relates to a method for selecting a passenger compartment air filter of a user's motor vehicle via a terminal configured for communicating with a remote data server, the said server comprising at least a data storage platform in which are listed a plurality of motor vehicle passenger compartment air filters and their characteristics and comprising a data base of user profiles. According to the invention, the said method comprises the following steps:
retrieve, by at least one processing means of the terminal, at least one item of information of identification of a user profile from among the user profiles stored in the user profiles data base,
retrieve, by at least one processing means of the terminal, at least one parameter of identification of the model of the user's motor vehicle,
retrieve, by at least one processing means of the terminal, data of utilisation of the said vehicle by the user,
construct, by at least one processing means of the terminal or a data processing platform of the said server configured for receiving the utilisation data retrieved by the said at least one processing means of the terminal, a utilisation history of the said vehicle on the basis of the utilisation data retrieved for a predefined minimum period of time,
establish a communication between the terminal and the remote data storage platform listing a plurality of passenger compartment air filters,
analyse, by at least one processing means of the terminal or at least one processing means of the said server, the compatibilities of the listed passenger compartment air filters with the identified model of the motor vehicle,
select, from among the compatible air filters, at least one air filter suitable for the user as a function of the identified user profile and for the utilisation history of the said vehicle, by at least one processing means of the terminal or at least one processing means of the said server, and
display at least one item of information of the said at least one selected air filter on a display interface.

Thus, an air filter is recommended based on the characteristics of the air filter not only as a function of the compatibilities with the model of the user's motor vehicle, but also as a function of the user and of his profile, for example if he is asthmatic or not, and also as a function of the utilisation history of the vehicle, that is to say where and in what conditions the vehicle is used, for example in what pollution environment the vehicle moves, the type of pollutants encountered, or other things.

The said method can also comprise one or more of the following features, taken separately or in combination.

According to one aspect of the invention, the said method comprises a preliminary step of entering into the user profile identification data of the user and data related to the health of the user.

The data related to the health of the user comprise for example at least one of the following items of data: an allergy, a state of health, a chronic illness, a disease of the respiratory tract such as asthma, respiratory failure, a cardiovascular disease, heart failure, the identification of at least one pollutant affecting the respiratory tract and/or the heart, a pregnancy.

Data on the environment of the user can be entered into the user profile. The environmental data can comprise for example at least one item of data from among the identification data and data related to the health of the occupants of the said vehicle other than the said user, and at least one item of data of identification of allergenic pets.

According to a variant embodiment, the information on the selected air filter is displayed in the case of detection of the approach of a season during which a concentration of at least one allergen in the air is likely to trigger an allergic episode of an occupant of the said vehicle for whom an allergy is identified in the data related to health.

It is for example a pollination season of a plant species to which an allergy is identified. It can also be a season or mid-season of a year, like the spring. It can also be a meteorological episode conducive to the dispersion of allergens.

As a variant or as a complement, the information on the selected air filter is displayed in the case of detection of the approach of a due date or of a predefined mileage for replacing the air filter.

According to another aspect of the invention, on the basis of the said at least one parameter of identification of the motor vehicle model, the said method comprises the following steps:
identify an air blower of a heating and/or ventilation and/or air conditioning installation of the said motor vehicle, the air filter being configured for being fitted in the said installation, and
identify at least one item of data on the power of the air blower.

The utilisation data of the motor vehicle comprise for example at least one item of data from among the following data: geo-positioning of the said vehicle, journeys carried out, initial and final positions, mileage completed, duration of each journey, recurrence of journeys, identification of at least one pollutant during each journey, pollution levels of the said at least one pollutant identified during each journey, topography of the places traversed during each journey, population density at the initial and final positions and of the places traversed, the fatigue level of the driver during the journeys.

The predefined minimum period of time for the utilisation history of the motor vehicle is one month, preferably six months.

According to yet another aspect of the invention, at least one criterion for the recommendation of a maximum exposure threshold for at least one pollutant can be used for the step of determination of at least one air filter. The said method can comprise the following sub-steps:
compute, for a predefined duration, the average of the pollution level of at least one identified pollutant to which the user is exposed,
compare the computed average with the recommended maximum threshold for the said at least one pollutant over the predefined duration, and
as a function of the comparison results, determine at least one air filter to be recommended so that the exposure to the said at least one identified pollutant is below the recommended maximum threshold.

The said method can also comprise a step of identification and of display of an address of an internet site or of a postal address where the said at least one air filter where the said at least one selected air filter can be purchased.

The invention also relates to a terminal configured for at least partly implementing the said method such as defined above.

The said terminal comprises at least one processing means configured:
to retrieve at least one item of information of identification of a user profile,
to retrieve at least one identification parameter of the user's motor vehicle model,
to retrieve data on the utilisation of the said vehicle by the user,
to construct a utilisation history of the said vehicle on the basis of the retrieved utilisation data for a predefined minimum period of time,
to establish a communication with a remote data storage platform listing a plurality of passenger compartment air filters,
to analyse the compatibilities of the listed passenger compartment air filters with the identified motor vehicle model,
to determine, from among the compatible air filters, at least one air filter suitable for the user as a function of the identified user profile and of the utilisation history of the said vehicle, and
to control the display of at least one item of information of the said at least one selected air filter on a display interface.

The terminal can comprise a satellite geo-positioning and routing system.

The display interface can be integrated or not in the terminal.

The display interface can show several windows for the simultaneous display of an item of information, such as an image or photo, about the said at least one selected air filter, and one of more items of data from the user profile.

The terminal can also comprise an acquisition interface by means of which the user can enter a user profile.

The acquisition interface can be formed by the display interface.

The terminal can be a fixed terminal installed in the motor vehicle.

The terminal can be a mobile terminal of the user.

The invention also relates to a motor vehicle comprising such a terminal installed in the said vehicle.

The said vehicle can comprise at least one pollution sensor configured for measuring the level of at least one pollutant in the environment of the said vehicle.

Other features and advantages of the invention will become apparent on reading the following description, given with reference to the appended figures, among which:

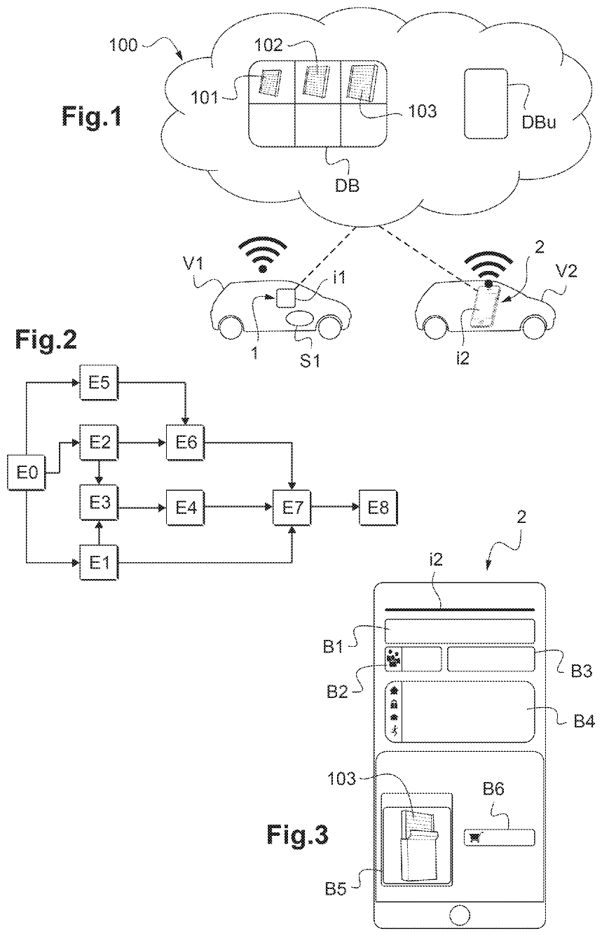

FIG. 1 is a diagrammatic representation of motor vehicles in which terminals are connected to a remote data server,

FIG. 2 is a simplified flow chart showing the steps of a method for selecting passenger compartment air filters, and

FIG. 3 is a diagrammatic representation of a terminal allowing the implementation of at least some of the steps of the method for selecting air filters.

In these figures, identical elements have the same references.

The following embodiments are examples given by way of illustration of the subject of the invention. The invention is not limited to these embodiments. Although the description refers to one or several embodiments, this does not necessarily signify that each reference relates to the same embodiment, or that the features apply only to one embodiment. Single features of different embodiments can also be combined or interchanged in order to provide other embodiments.

Certain elements can be indexed in the description or, in other words, it is possible for example to mention a first element or a second element. In this case, it is a matter of simple indexing in order to differentiate and designate similar but not identical elements. This indexing does not imply a priority of one element with respect to another. Such designations can easily be interchanged without departing from the context of the present invention.

Motor vehicles V1, V2 are shown in a diagrammatic manner in FIG. 1. Each motor vehicle V1, V2 may or may not comprise at least one pollution sensor S1. In the example shown in FIG. 1, only the motor vehicle V1 comprises a pollution sensor S1. The pollution sensor S1 makes it possible to measure the level of at least one pollutant in the environment of the motor vehicle V1.

It can be a matter of so-called connected vehicles, like the motor vehicle V1 in the example shown in FIG. 1, configured for exchanging with a remote data server 100, by the intermediary of a network, and/or for exchanging with nearby vehicles.

The remote data server 100 notably comprises at least a data storage platform DB in which are listed passenger compartment air filters for motor vehicles and their characteristics. It is a remote data storage platform DB.

The remote data server 100 can also comprise a data base DBu in which user profiles are stored. It is a remote data base DBu of user profiles.

The invention relates to a method for selecting at least one air filter 101, 102, 103 for the passenger compartment of a motor vehicle V1, V2, from among a plurality of air filters 101, 102, 103 listed in the remote data storage platform DB.

With reference to FIGS. 1 and 2, the method for selecting at least one passenger compartment air filter can comprise a preliminary step E0 for creating and entering information into a user profile. The user profile can be stored in the data base DBu. The user can enter information into, complete or update his user profile at any time.

In particular, the user can enter into the user profile identification data of the user and one or more items of data related to the health of the user.

The identification data of the user can comprise an identifier, for example his forename and/or his name, possibly the gender and the age, the address or even the workplace.

In a non-exhaustive manner, examples of data related to the health of the user can be mentioned: an allergy, a state of health, a chronic illness, a disease of the respiratory tract such as asthma, respiratory failure, a cardiovascular disease, heart failure, the identification of at least one pollutant affecting the respiratory tract and/or the heart, a pregnancy. The user can enter several of these items of data.

The user can also enter data on his environment into his user profile. The data on the environment of the user for example comprise information on the user's family situation, the other members of his family, that is to say whether there is a spouse or one or more children.

The data on the environment of the user can be identification data and data related to the health of the occupants of the motor vehicle V1 or V2 other than the said user, it is notably a matter of regular occupants of the motor vehicle V1 or V2 such as the other members of the family As a variant or complement, the data on the environment of the user can comprise at least one item of identification of allergenic pets, such as dogs or cats.

The user profile can thus comprise personal data enhanced with information on his health and/or his environment. The term “enriched user profile” can be used.

For the selection of an air filter, the method comprises a first step E1 of retrieving at least one item of information of identification of a user profile.

During a second step E2, at least a first parameter of identification of the model of the user's motor vehicle model V1 or V2 is retrieved.

From this parameter or from several parameters of identification of the model of the motor vehicle V1 or V2, there can notably be identified the air blower which is used in the heating and/or ventilation and/or air conditioning installation of the motor vehicle V1 or V2 in which the air filter can be fitted. In particular, at least one item of information on the power of that air blower can be identified.

In fact, for the choice of the air filter, it is advantageous to take into account the power of the air blower, because the air filter can induce large pressure drops reducing the air flow passing through the air filter, and therefore the performance of the heating and/or ventilation and/or air conditioning installation.

The pressure drop of an air filter is proportional to its efficiency. Depending on the air filter, if it generates a lot of pressure drops, as can be the case with a combined air filter or an air filter with an additional function, it can happen that the air blower does not have sufficient power, depending on the model or the range of the motor vehicle V1 or V2.

The air filter will preferably be chosen in order to reduce the pressure drops.

Data on the utilisation of the motor vehicle V1 or V2 by the user can be retrieved.

It is a matter of a step E3 which can be implemented several times, more precisely each time a motor vehicle V1 or V2 is used over a predefined and sufficiently long period of time. The minimum predefined period of time is one month, preferably six months.

In a non-exhaustive manner, the utilisation data of the motor vehicle V1 or V2 can comprise one or more of the following items of data: geo-positioning of the motor vehicle V1 or V2, journeys carried out, initial and final positions, mileage completed, duration of each journey, recurrence of journeys, identification of at least one pollutant during each journey, pollution levels of the said at least one pollutant identified during each journey, topography of the places traversed during each journey, population density at the initial and final positions and of the places traversed, the fatigue level of the driver during the journeys.

These items of utilisation data thus make it possible to identify if the user is or is not driving in town, on a motorway, if it is a matter of short journeys or of long journeys, if he is tired, if he is or is not driving in a pollution environment, the pollutant or pollutants to which he is subjected, for example if he virtually only drives in town whilst being subjected to certain pollutants particles or gas.

On the basis of one or more of these items of utilisation data, a history of utilisation of the motor vehicle V1 or V2 can be constructed in step E4.

In step E5, a communication can be established with the remote data storage platform DB listing the air filters 101, 102, 103. The method comprises moreover a step E6 of analysis of the compatibilities of the listed passenger compartment air filters 101, 102, 103 with the motor vehicle model V1 or V2 identified from the parameter retrieved in step E2. Step E6 makes it possible to identify, from among these listed passenger compartment air filters 101, 102, 103, the air filters compatible with the identified motor vehicle model V1 or V2.

Subsequently, in step E7, at least one air filter is selected from among the compatible air filters for the identified motor vehicle model V1 or V2, taking into account the user profile identified in step E1 and the history of the utilisation of the motor vehicle V1 or V2 constructed in step E4.

The selection of an air filter is based on the characteristics of the air filter so that it is simultaneously suitable for the motor vehicle model V1 or V2, notably for the power of the air blower, and for the user, notably if he has illnesses and/or allergies, if he has children, dogs, cats, but also for the use made of that motor vehicle V1 or V2 according to the available history, that is to say globally where and in what conditions the user drives.

Thus, for example, a suitable air filter can be recommended depending on one or more occupants of the motor vehicle V1 or V2 having or not having allergies or a particular state of health, depending on whether the driving is rather in town or in the country, and depending on the pressure drop authorized for the motor vehicle model V1 or V2.

Additionally, other criteria can be taken into account for the selection of the air filter, other criteria which can be much more particular with regard to the use.

For example, one criterion can be a criterion of recommendation of a maximum exposure threshold for at least one pollutant. Exposure criteria are generally provided by the World Health Organization. It can be a recommendation for an exposure per day, or per month or per year or for any other unit of time such as a number of hours.

In this case, the method can comprise a sub-step of computing the average of the pollution level of one or more pollutants to which the user is exposed, for a predefined duration. The computed average can then be compared with the recommended maximum threshold for each pollutant over the predefined duration.

As a function of the comparison results, the air filter can be selected such that the exposure to each identified pollutant is below the recommended maximum threshold.

Subsequently, a command to display at least one item of information on the selected air filter can be generated and this information can be displayed in step E8.

The display of the information on the air filter forms a recommendation to the user. The information can be displayed in the form of an image or photo of the air filter and/or of a text, for example with the reference of the selected air filter.

Such an air filter selection and recommendation can happen in the case of detection of the approach of a season during which a concentration of at least one allergen in the air is likely to trigger an allergic episode of an occupant of the motor vehicle V1 or V2 for whom an allergy is identified in the health-related data.

It is for example a season of pollination of a plant species to which an allergy is identified.

It can also be a season of mid-season of a year, like the spring.

It can also be a meteorological episode conducive to the dispersion of allergens.

As a variant or in addition, the information of the selected air filter can be displayed on the approach of a due date or of a predefined mileage for replacing the air filter.

It is also possible to provide a step of identification of an internet site address or of a postal address where the selected air filter can be purchased. The address of or a link to an internet site or coordinates on a navigation map can for example be displayed in step E8.

The order of at least some of the steps of the method such as described above can be reversed.

Such a method can be used at least partly by a user's terminal 1, 2.

A terminal is understood to mean any type of equipment capable of exchanging data, requests, messages and other contents with the remote data server 100, in particular with the remote data storage platform.

The terminal can be installed in the motor vehicle such as shown diagrammatically by the reference 1 for the motor vehicle V1. It can also be a mobile terminal of a user such as shown diagrammatically by the reference 2. The mobile terminal mobile can be a so-called intelligent mobile telephone, more commonly called a “Smartphone” by anglicism, or it can be a tablet.

Each terminal 1, 2 can comprise a satellite geo-positioning system known by the terms “GPS” and “routing”.

Moreover, each terminal 1, 2 advantageously comprises an acquisition interface allowing the user to create and complete his user profile.

Each terminal 1, 2 can comprise a display interface i1, i2.

The acquisition interface can be formed by the display interface i1, i2, particularly in the case of a terminal with a touch-sensitive display screen.

Each terminal 1 or 2 comprises one or more processing means making it possible to at least partially implement the method for selecting an air filter. Each terminal 1 or 2 can notably comprise one or more telecommunications or telematics means, at least one computer, a processor and/or any other hardware making it possible to execute software or not, an integrated circuit suitable for an application known by the acronym ASIC, a read only memory known by the acronym ROM, a random access memory known by the acronym RAM, or another memory, or other conventional or personalized items of hardware.

The one or more processing means can be configured:
to retrieve at least one item of information of identification of a user profile,
to retrieve at least one parameter of identification of the user's motor vehicle model V1 or V2,
to retrieve data on the use of the motor vehicle V1 or V2 by the user.

According to a variant embodiment, a processing means of the terminal 1 or 2 can be provided for constructing a history of use of the motor vehicle V1 or V2 on the basis of the utilisation data retrieved over a predefined minimum period of time.

Alternatively, the construction of the history can be carried out in the remote data server 100 distant using the data exchanged with the terminal 1, 2. In this case, the terminal 1, 2 can comprise a means of transmission of the retrieved data to the remote data server 100 which can comprise a data processing platform configured for receiving the retrieved data and constructing the history of the basis of this retrieved data.

Moreover, one of more processing means of the terminal 1 or 2 can be provided for:
establishing a communication with the remote data storage platform DB listing a plurality of passenger compartment air filters,
analysing the compatibilities of the listed passenger compartment air filters with the identified motor vehicle model V1 or V2, and
determining, from among the compatible air filters, at least one air filter suitable for the user as a function of the identified user profile and of the utilisation history of the motor vehicle V1 or V2.

Alternatively, one or more processing means of the remote data server 100 can be configured for analysing the compatibilities of the passenger compartment air filters listed in the data storage platform DB with the identified motor vehicle model V1 or V2 and determining, from among the compatible air filters, at least one air filter suitable for the user as a function of the identified user profile and of the history of use of the motor vehicle V1 or V2.

Finally, the terminal 1 or 2 can comprise a processing means for controlling the display of at least one item of information of the selected air filter on a display interface i1, i2.

The display can be produced on a display interface i1, i2 of the terminal 1 or 2 having made it possible to implement one or more steps of the method or on a display interface of another terminal. In other words, the display interface i1, i2 may or may not be integrated in the terminal 1 or 2 having made it possible to at least partly implement the method.

The display interface i1, i2 can have several display windows B1, B2, B3, B4, B5, B6, for the simultaneous display of several items of information and/or contents. One or more items of data of the user profile can also be displayed. The display of these items of data can possibly be accompanied by the display of pictograms or simplified graphics making it possible to quickly identify the information in question, such as for example the pictogram of a family in the window B2, intended to be displayed beside an item of information on the family situation of the user, or of a house in the window B4 intended to be displayed beside an address of the user. Similarly, an item of data relating to the possibility of purchasing a recommended air filter, like a link to the address of an internet site or a postal address, can be displayed, possibly accompanied by a pictogram of a shopping trolley, in the window B6.

Thus, the method such as described above makes it possible to help better protect the user of a motor vehicle V1 or V2 with resect the pollutants and/or allergens encountered, for example over the current year, or the last six months, by combining all of the known information on the user, on his motor vehicle V1 or V2 and on the use of that motor vehicle V1 or V2 for the selection of an air filter 101 or 102 or 103 which is simultaneously suitable for the user and for the motor vehicle V1 or V2 as a function of its use.

Moreover, the fact of combining all of these items of data makes it possible to avoid recommending an air filter inducing a pressure drop which could not be supported by the air blower of the user's motor vehicle V1 or V2.

1. A method for selecting a passenger compartment air filter of a user's motor vehicle via a terminal configured for communicating with a remote data server, the server comprising at least a data storage platform in which are listed a plurality of motor vehicle passenger compartment air filters and corresponding characteristics and comprising a data base of user profiles, the method comprising:
retrieving, by at least one processing means of the terminal, at least one item of information of identification of a user profile from among the user profiles stored in the user profiles data base;
retrieving, by at least one processing means of the terminal, at least one parameter of identification of the model of the user's motor vehicle;
retrieving, by the at least one processing means of the terminal, data of utilisation of the vehicle by the user;
constructing, by the at least one processing means of the terminal or a data processing platform of the server configured for receiving the utilisation data retrieved by the at least one processing means of the terminal, a utilisation history of the vehicle on the basis of the utilisation data retrieved for a predefined minimum period of time;
establish a communication between the terminal and the remote data storage platform listing a plurality of passenger compartment air filters;
analyse, by at least one processing means of the terminal or at least one processing means of the server, the compatibilities of the listed passenger compartment air filters with the identified model of the motor vehicle,
select, from among the compatible air filters, at least one air filter suitable for the user as a function of the identified user profile and for the utilisation history of the vehicle, by at least one processing means of the terminal or at least one processing means of the said server; and
display at least one item of information of the at least one selected air filter on a display interface.

2. The method according to claim 1, further comprising a preliminary step of entering into the user profile identification data of the user and data related to the health of the user.

3. The method according to claim 2, wherein the data related to the health of the user comprise for example at least one selected from the group consisting of the following items of data: an allergy, a state of health, a chronic illness, a disease of the respiratory tract such as asthma, respiratory failure, a cardiovascular disease, heart failure, the identification of at least one pollutant affecting the respiratory tract and/or the heart, a pregnancy.

4. The method according to claim 2, wherein data on the environment of the user is entered into the user profile, the environmental data comprising at least one item of data from among the identification data and data related to the health of the occupants of the said vehicle other than the said user, and at least one item of data of identification of allergenic pets.

5. The method according to claim 1, wherein on the basis of the said at least one parameter of identification of the motor vehicle model, the method further comprises:
identifying an air blower of a heating and/or ventilation and/or air conditioning installation of the motor vehicle, the air filter being configured for being fitted in the said installation; and
identifying at least one item of data on the power of the air blower.

6. The method according to claim 1, wherein the utilisation data of the motor vehicle comprise at least one item of data selected from the group consisting of: geo-positioning of the said vehicle, journeys carried out, initial and final positions, mileage completed, duration of each journey, recurrence of journeys, identification of at least one pollutant during each journey, pollution levels of the said at least one pollutant identified during each journey, topography of the places traversed during each journey, population density at the initial and final positions and of the places traversed, the fatigue level of the driver during the journeys.

7. The method according to claim 1, wherein at least one criterion for the recommendation of a maximum exposure threshold for at least one pollutant is used for the step of determination of at least one air filter, and the method further comprises:
computing, for a predefined duration, the average of the pollution level of at least one identified pollutant to which the user is exposed,
comparing the computed average with the recommended maximum threshold for the said at least one pollutant over the predefined duration, and
as a function of the comparison results, determine at least one air filter to be recommended so that the exposure to the said at least one identified pollutant is below the recommended maximum threshold.

8. A terminal configured for at least partly implementing the method according to claim 1, the terminal comprising:
at least one processing means configured to:
retrieve at least one item of information of identification of a user profile,
retrieve at least one identification parameter of the user's motor vehicle model,
retrieve data on the utilisation of the said vehicle by the user,
construct a utilisation history of the said vehicle on the basis of the retrieved utilisation data for a predefined minimum period of time,
establish a communication with a remote data storage platform listing a plurality of passenger compartment air filters,
analyse the compatibilities of the listed passenger compartment air filters with the identified motor vehicle model,
determine, from among the compatible air filters, at least one air filter suitable for the user as a function of the identified user profile and of the utilisation history of the said vehicle, and
control the display of at least one item of information of the said at least one selected air filter on a display interface.

9. The terminal according to claim 8, further comprising an acquisition interface by which the user enters a user profile.

10. A motor vehicle comprising a terminal according to claim 8 installed in the vehicle.
